(19) United States
(12) Patent Application Publication
(10) Pub. No.: US 2020/0272901 A1
(43) Pub. Date: Aug. 27, 2020

(54) OPTIMIZATION APPARATUS, OPTIMIZATION METHOD, AND NON-TRANSITORY COMPUTER READABLE MEDIUM

(71) Applicant: Preferred Networks, Inc., Tokyo-to (JP)

(72) Inventors: Takuya INOUE, Tokyo-to (JP); Mitsuru KUSUMOTO, Tokyo-to (JP); Gentaro WATANABE, Tokyo-to (JP)

(73) Assignee: Preferred Networks, Inc., Tokyo-to (JP)

(21) Appl. No.: 16/798,880

(22) Filed: Feb. 24, 2020

(30) Foreign Application Priority Data
Feb. 25, 2019 (JP) 2019-031923

(51) Int. Cl. G06N 3/08

(52) U.S. Cl. CPC G06N 3/08

(57) ABSTRACT

An optimization apparatus includes one or more memories and one or more processors. For an operation node constituting a representation of an operation of a neural network, the one or more processors are configured to calculate a time consumption for recomputing an operation result of a focused operation node, from another operation node whose operation result has been stored, and acquire data on the operation node whose operation result is to be stored, based on the time consumption.

### CROSS REFERENCE TO RELATED APPLICATIONS

This application claims the benefit of and priority to Japanese Patent Application No. 2019-031923, filed on Feb. 25, 2019, the entire contents of which are incorporated herein by reference.

### FIELD

The embodiments described herein relate to an optimization apparatus, an optimization method, and a non-transitory computer readable medium.

### BACKGROUND

In machine learning, training is often performed by a forward propagation process and a backward propagation process based on the result of the forward propagation process. When executing the backward propagation process, numerical values computed in each layer in the forward propagation process may be needed, and these computation results may be required to be stored. For the learning of a deep learning model, GPU (Graphics Processing Unit) is often used, but the available memory is finite and therefore becomes an obstacle at the time when using a high-resolution image, a large batch size, or the like. In the case where there are numerical values and the like which cannot be stored in the memory, the backward propagation is executed by performing the forward propagation process again up to the position where an interim progress is needed. In the case of performing the above recomputation, if the recomputation of all of the numerical values is performed, the training time often increases. To avoid the increase in time, there is a method of saving the interim progress in the memory to a certain degree. However, which interim progress is to be stored in the memory is arbitrary decided, so that it is difficult to select the numerical value and so on to be stored in the memory because the computation time greatly differs depending on which numerical value and the like are to be stored.

### BRIEF DESCRIPTION OF THE DRAWINGS

FIG. 1 is a chart illustrating an example of graph data;

FIG. 2 is a chart illustrating an example of the vicinity in the graph data;

FIG. 3 is a chart illustrating an example of a lower set;

FIG. 4 is a chart illustrating an example of a lower set;

FIG. 5 is a block diagram illustrating the functions of an optimization apparatus according to an embodiment;

FIG. 6 is a flowchart illustrating the flow of processes of optimization according to an embodiment; and

FIG. 7 is a diagram illustrating a hardware implementation example of the apparatus.

### DETAILED DESCRIPTION

According to some embodiments, an optimization apparatus may include one or more memories and one or more processors. The one or more processors may be configured to, for an operation node constituting a graph representing an operation of a neural network, calculate time consumption for recomputation in a focused operation node, from another operation node whose operation result has been stored, and acquire data on the operation node whose operation result is to be stored, based on the time consumption.

Hereinafter, embodiments are explained in detail referring to the drawings. Note that the drawings are schematically illustrated as examples and the embodiments are not limited to these drawings.

First, the outline of this embodiment is explained. In a computation graph representing processes of forward propagation and backward propagation in this embodiment, a node represents an input of a variable or a computation result and an edge represents a dependency relationship for computing the variable. This graph is expressed, for example, by DAG (directed acyclic graph).

More specifically, when other variables w₁, w₂, . . . , wₖ are necessary to compute a variable v, nodes corresponding to the variables v, w₁, w₂, . . . , wₖ and edges (w₁, v), (w₂, v), . . . , (wₖ, v) corresponding to the edges exist in the graph.

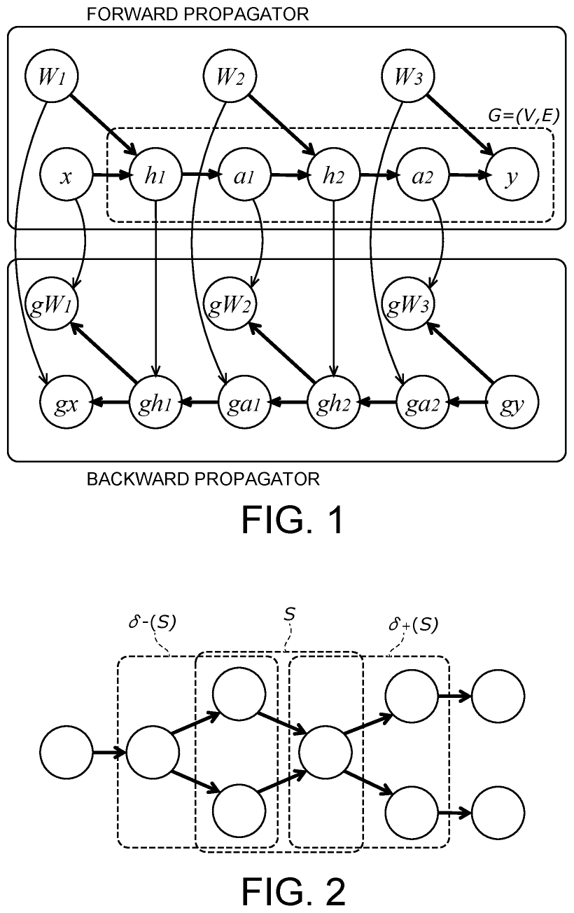

FIG. 1 is a graph representing states of the forward propagation and the backward propagation in the training. In the computation graph, a node having an indegree of 0 is called an input node, and a node having an outdegree of 0 is called an output node. The nodes other than them are called intermediate nodes. The computation graph may include a forward propagator which computes the values of the variables, and a backward propagator which expresses the gradient computation of them.

Thick arrows in the drawing represent edges in the processes of the forward propagation and the backward propagation. On the other hand, thin arrows represent results of the forward propagation or edges representing dependence from the input nodes in the backward propagation. For explanation, a portion corresponding to the intermediate nodes and the output node in the forward propagator is described as a graph G=(V, E).

x is input data and y is output data. W₁, W₂, W₃ are variables necessary to obtain intermediate variables h₁, h₂, h₃ respectively by a predetermined operation, and are input variables which may be updated by training. For example, the intermediate variable h₁ is acquired by performing an operation about the input data x and the input variable W₁ in a certain layer constituting a neural network. By similarly performing an operation about the intermediate variable h₁ in the next layer, a₁ is acquired. By performing an operation in the final layer, the output data y is acquired. The node represents input of a variable or an operation result as explained above and, in each of the nodes other than the input nodes, the result of the operation (an output variable in a layer corresponding to the node) is described in the node. In other words, as illustrated in drawings (e.g., FIG. 1), the graph G=(V, E) includes operation nodes representing h₁, a₁, h₂, a₂, y but excludes edges and the input nodes corresponding to x, W₁, W₂, W₃ which are nodes representing the input data and the input variables from the forward propagator.

Also in the backward propagator, by similarly repeating the operation in each layer, an error may be backwardly propagated. For example, a gradient gy may be calculated based on the output data y. Based on the input variable W₃ and the gradient gy, ga₂ may be acquired. Based on the intermediate variable a₂ and the gradient gy, a gradient gW₃ may be acquired. In the above manner, the backward propagation process may be executed based on the graph using the input variables and the intermediate variables being the nodes in the forward propagator.

In this case, for example, when the intermediate variable a₂ is stored in a memory in the forward propagation process, gW₃ may be acquired by performing the backward propagation process using gy and a₂ stored in the memory. Conversely, in the case where a₂ is not stored in the memory and when h₂ is stored in the memory, a₂ may be acquired by recomputation based on the forward propagation process using h₂, and gW₃ may be acquired using the acquired a₂. In the case where h₂ is not stored either in the memory, the forward propagation process may be performed while going back to the variable which is stored in the memory and is necessary to acquire h₂, and h₂ may be acquired by recomputation, and then a₂ may be acquired by recomputation.

As explained above, the variable not stored in the memory can be acquired by performing the recomputation of the forward propagation process based on the variable stored in the memory, and the backward propagation process can be executed. This process may be repeated until the backward propagation process at a necessary part up to the input data and each input variable is finished.

In the computation of the neural network, the input nodes and the output nodes may consume less memory (e.g., less memory than that consumed by the intermediate nodes). On the other hand, the intermediate nodes often consume much memory. In other words, the cause to reduce the memory may be the variables in a portion of the graph G. In order to reduce the training time in the limited memory, which variables in the graph G are to be stored in the memory and which variables are to be acquired by recomputation may be determined or optimized.

The definition used for the optimization is explained. FIG. 2 shows an extracted part of the graph as an example. Attention is focused on a set S of nodes. S is a subset of V (S⊆V) where V is a set of all of the nodes in the graph G. It is assumed that the time taken to compute the variable corresponding to the node v in the graph G is Tv and the amount of memory necessary to store the variable is Mv. These values are nonnegative integers.

Tv is indicated, for example, by an integral multiple of a unit time, or an index of time expressed by an integer which is considered to be taken for the computation for each node. Mv is expressed, for example, by an index representing the amount of memory such as a bit, a byte or the like. It is defined that T(S)=Σ_{v∈S}Tv, M(S)=Σ_{v∈S}Mv for the node set S.

As illustrated in FIG. 2, it is assumed that δ⁻(S) is a set of the nodes entering v∈S and δ⁺(S) is a set of the nodes going out of v∈S with respect to the node set S⊆V.

In this embodiment, in the case where there is no edge directing from V-L to L with respect to a node set L⊆V, L is described as a lower set. “−” represents a difference set (a complementary set for a universal set). With respect to L, the boundary of L is defined as ∂(L)=δ⁻(V−L)∩L. A family of sets composed of all of the lower sets of the graph G is described as L_{G}. According to this description, V and an empty set φ are included in L_{G}.

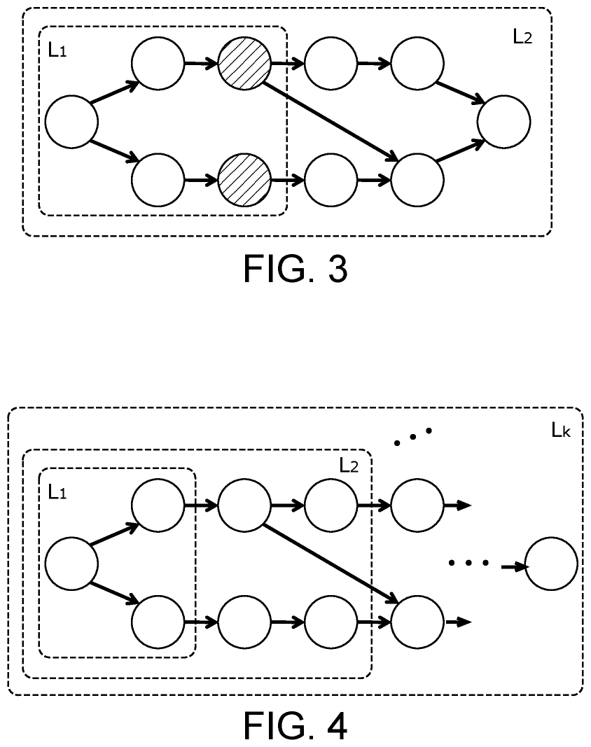

FIG. 3 is a chart illustrating a lower set and its boundary. For example, all of the nodes and edges in the graph G are illustrated. In this case, L₂=V, and L₁ is a subset of L₂. Since there is no edge directing to the node of L₁ in the set L₂−L₁, L₁ is a lower set of L₂. According to the above definition, the nodes illustrated with diagonal lines are a boundary am of L₁.

The example of L₂=V is illustrated without limitation to this. FIG. 4 is a chart illustrating an example of a graph including many lower sets. As illustrated, the graph G may be composed to include a set V of the nodes including many lower sets. In this case, V=Lₖ, and L_{G} includes sets of L₁, L₂, . . . , Lₖ. Note that extremely simple computation graphs are illustrated in FIG. 3 and FIG. 4, which are illustrated as examples, and the same definition can be made for a network structure having a more complicated graph.

With the above definition, it is possible to decide an increasing sequence (L₁, L₂, . . . , Lₖ) of the lower set of L₁⊂L₂⊂ . . . ⊂Lₖ=V for the lower sets of the nodes included in the graph G. It is possible to execute the computation of forward propagation and the computation of backward propagation based on the increasing sequence. Hereinafter, the increasing sequence is also described as a strategy.

Here, it is assumed that V₁=L₁, and V₁=(i≥2). Under the definition of the lower set in this embodiment, Lᵢ=Vᵢ∪V₂∪ . . . ∪Vᵢ, and, for arbitrary j<i, the nodes of Vᵢ can be reached from the nodes of Lⱼ.

In the forward propagation, the operation may be executed in the order of V₁, V₂, . . . , Vₖ. There may be a plurality of orders in which each node of Vᵢ is computed, and the computation may be made in any of the orders. After completion of the computation of Vᵢ, the computation result of Vᵢ may be released from the memory except for the nodes of ∂(Lᵢ).

In the backward propagation, the gradient of the node of each Vᵢ may be computed in the order of Vₖ, Vₖ₋₁, . . . , V₁ conversely to the forward propagation. In computing the gradient of Vᵢ, the computation result in the forward propagation of Vᵢ may be necessary. In the case where the computation result of Vᵢ is stored in the memory, the gradient may be computed using the stored value. On the other hand, in the case where the computation result of Vᵢ is not stored in the memory, the recomputation is performed from stored in the memory, the value of Vᵢ may be acquired by performing computation similarly in the forward propagation, and the gradient may be computed (e.g., using the acquired value of Vᵢ). Also in the backward propagation, the gradient of each node of Vᵢ may be acquired similarly in the forward propagation. In some embodiments, after the operation of parameter update or the like using the gradient is finished, the gradient information except for the nodes of δ⁺(Lᵢ₋₁)∩Vᵢ may be erased.

It is assumed that a vertex set saved in the memory after finish of an i-th step at the timing of the forward propagation is which can be expressed as U; =uⁱⱼ₌₁ ∂(Lⱼ). The memory usage after all of the processes in the forward propagation are finished can be expressed as Uₖ. Since the above recomputation does not need to be performed as in the above manner for these nodes, a time Σ_{v∈Uk}Tv for performing recomputation for these nodes is a time which can be reduced as compared with the case of performing recomputation for all of them.

The amount of memory consumption may differ in the computation stage. The peak of the memory consumption may be at the timing during the backward propagation process. In the case of computing the gradient of the vertex set Vᵢ, the vertex set immediately after the finish of the i-th step in the forward propagation is Uᵢ. At the timing before the recomputation, a memory of M(Uᵢ₋₁) may be consumed. Further, it is necessary to execute recomputation for the intermediate nodes in Vᵢ to compute the gradient. This may consume a memory of 2M(Vᵢ).

Further, the computation result of a node adjacent to Vᵢ is possibly needed for gradient computation. For example, the gradient information at a step before Vᵢ is sometimes needed. In this case, the memory of M(δ⁺(Lᵢ)−Lᵢ) may be utilized for the execution of the operation. Further, for example, there is an operation of h=f(v₁, v₂, v₃) in the forward propagation, the information on v₁, v₃ may be used for the operation of the gradient of v₂. In this case, a memory of M(δ⁻(δ⁺(Lᵢ))−Lᵢ) may be utilized for the execution of the operation.

A sum of the four memory consumptions may be established or calculated as Mᵢ=M*Uᵢ₋₁)+2M(Vᵢ)+M(δ⁺(Lᵢ)−Lᵢ)+M(δ⁻(δ⁺(Lᵢ))−Lᵢ). In some embodiments, a peak value max_{i∈{1, 2, . . . , k}}Mᵢ of the memory consumption is used for optimization. In some embodiments, a problem to minimize the training time in a state where a memory budget B to be allocated to the training depending on the GPU or the like is known may be considered.

This comes down to solving the following optimization problem.

The computation graph G=(V, E) and the memory budget BEN are given. From among increasing sequences of the lower set with respect to G having the memory consumption falling within B, namely, maxᵢ Mᵢ≤B, the increasing sequence which minimizes the additionally occurring computation time can be found. When B is too small, there is a case where the increasing sequence satisfying the constraint does not exist, in which case “absence” may be output.

Note that though only the total number of the consumption memories is taken into consideration in formulation of this problem, it may be decided where the information on the variable is actually located on the memory such as GPU or the like. If there is completely no room in the memory area, there is a possibility that the already reserved area needs to be relocated every time when the memory is reserved. However, such a situation may be easily avoided by estimating the memory budget B to be slightly smaller than the upper limit of the actually available memory amount. Further, the overhead actually taken for the relocation of the memory is not large.

The computation time Tᵥ of the node is an arbitrary value, but Tᵥ can be adjusted to be a small constant by performing discretization at a relatively rough granularity. Hereinafter, it is assumed that the total computation time T(V) of the nodes is small at a degree proportional to the number of nodes |V|. When it is assumed that T(V) is small enough, the number of family of lower sets L_{G} becomes small at a degree of the polynomial of the number of nodes |V| in the computation graph G in the actually used neural network. Hence, it is assumed hereinafter that the number of family of lower sets L_{G} is small at a degree of the polynomial of |V|. Tᵥ can be set to Tᵥ=round(n·Tᵥ/Tₘₐₓ), for example, by acquiring the maximum value Tₘₐₓ of an actual measured value Tᵥ and using an arbitrary natural number as n and a function for rounding a real number to an integer as round(⋅). The above is expressed as one example, and the definition of Tᵥ is not limited to this, but Tᵥ can be appropriately defined to be a fixed value or the like by operation as explained later.

This problem can be processed or solved based on the dynamic programming. What are to be satisfied in finding the increasing sequence (L₁, L₂, . . . , Lₖ) of the lower set are Lᵢ⊂Lᵢ₊₁ and Mᵢ≤B. For a certain lower set L and 0≤t≤T(V), the optimum memory consumption opt[L, t] may be set as the minimum value of the memory usage M(Uᵢ) of the variable Uᵢ which is not forgotten in execution of the forward propagation process among M(Uᵢ)s which satisfy the above constraint in (L₁, L₂, . . . , Lᵢ) and the last Lᵢ of the sequence is coincident with L and whose time consumption is equal to t. If such (L₁, L₂, . . . , Lᵢ) does not exist, opt[L, t]=∞ may be set.

The strategy to be finally determined or obtained is the case of L=V. When t satisfying opt[L, t]<∞ exists, a strategy of the computation time t exists. When a solution of the dynamic programming is restored based on the minimum t satisfying the condition, the original strategy can be obtained. It is assumed that if such t does not exist, there is no solution.

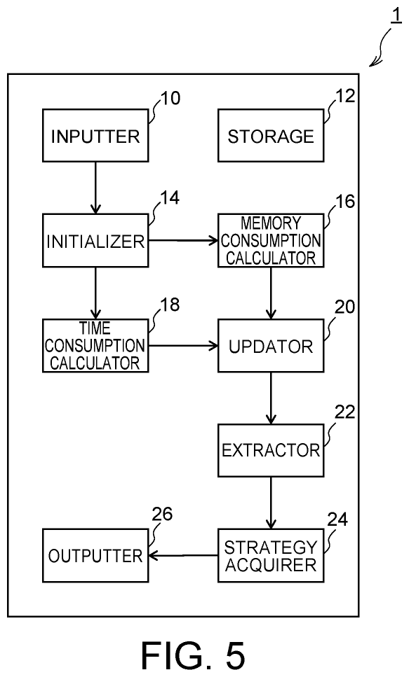

A configuration of the optimization apparatus according to this embodiment is explained. FIG. 5 is a block diagram illustrating the functions of the optimization apparatus according to this embodiment. An optimization apparatus 1 includes an inputter 10, a storage 12, an initializer 14, a memory consumption calculator 16, a time consumption calculator 18, an extractor 22, a strategy acquirer 24, and an outputter 26.

The inputter 10 may accept or receive input of various kinds of data used for optimization. The data used for optimization are, for example, graph data being an object of the optimization, consumption data on memory and time, and data on the memory budget and so on.

The storage 12 may store various kinds of data used for the optimization apparatus 1. For example, the data input from the inputter 10 may be stored in the storage 12, and each component may execute an operation referring to the data stored in the storage 12 at a necessary timing. Besides, data during operation, data on a result of the optimization and so on may be stored.

The initializer 14 may initialize the data used for the optimization. For example, initialization of the strategy may be executed. When it is executed using hardware by the program, the initializer 14 may execute reservation and so on of the memory for array or the like.

The memory consumption calculator 16 may calculate the memory consumption in the lower set included in L_{G}. For example, the amount of the memory consumption may be calculated based on the kinds of the above-explained four memory consumptions in a focused subset. Note that the focused subset means the subset being an object of estimation in the current loop in the loop operation.

The time consumption calculator 18 may calculate the time consumption in the lower set included in L_{G}. For example, the time consumption is calculated based on the focused time based on the above T(V). Note that the focused time means the time being an object of estimation in the current loop in the loop operation.

The updater 20 may update the amount of the memory consumption in the combination between the subset and time based on the memory consumption calculated by the memory consumption calculator 16 and on the time consumption calculated by the time consumption calculator 18 based on the focused time and the subset.

The extractor 22 may extract an optimum opt[V, t] in the set V of all of the nodes based on the amount of the memory consumption in the combination between the updated subset and time updated by the updater 20.

The strategy acquirer 24 may acquire an optimum strategy (L₁, L₂, . . . , Lₖ) based on the optimum opt[V, t] extracted by the extractor 22.

The outputter 26 may output the strategy acquired by the strategy acquirer 24. Note that the output is, of course, the output to the external part of the optimization apparatus 1, and may be a concept including storage in the storage 12.

In the case of performing recomputation for a focused operation node from a certain operation node existing closer to the input node than the focused node to the focused operation node, what degrees of memory consumption and time consumption are made may be calculated by the actions of the components. Further, when the memory consumption is equal to or smaller than the memory budget, the memory consumption may be stored as a minimum memory consumption. More specifically, in the case of using the result of any of the operation nodes existing closer to the input side than each operation node, what degree of the recomputation time is used to obtain the result of the operation node and what degree of the memory consumption is used to perform the recomputation may be calculated by repeating the later-explained action.

In this event, when the minimum memory consumption exists in each focused operation node, the minimum memory consumption and the total recomputation time taken up to the focused operation node in this case may be stored in association. By storing in this manner, the memory consumption and the time consumption in the focused operation node can be calculated even in the case where the output of each focused operation node is stored or not.

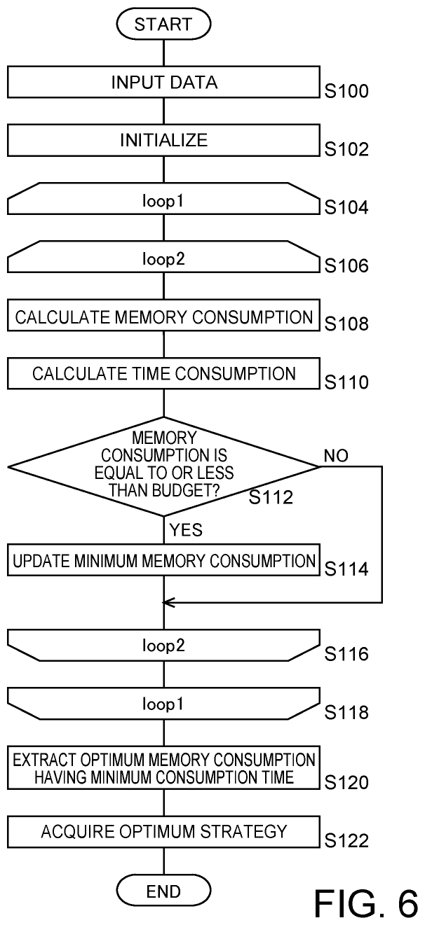

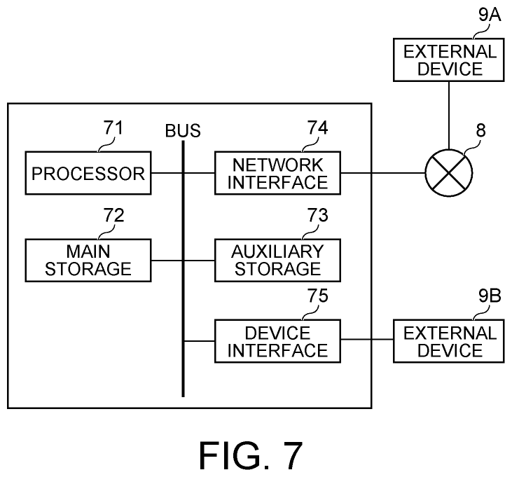

Next, the flow of the processes in the optimization apparatus 1 is explained. FIG. 6 is a flowchart illustrating the flow of the processes according to this embodiment.

First, the input of data may be received or accepted via the inputter 10 (S100). The input data is, for example, data on the configuration of the network. The data may be particularly data including data on the information on variables, nodes which perform operations, and edges indicating their flows, data on the memory consumption and the time consumption, and/or data on the memory budget. The data on the memory consumption is, for example, data including the memory consumption My in each node v. On the other hand, the data on the time consumption may be data including time Tᵥ taken for the operation when the input data is input in each node v. These input data may be stored in the storage 12. Further, these data may be the ones stored in the storage 12. In this case, the step at S100 may be omitted.

Next, the initializer 14 may perform initialization of the variable in the optimization (S102). The initialization may be performed with the set made by arraying all of the lower sets in the graph G in an ascending order of size as L_{order}. For example, the first element of L_{order} represents an empty set φ and the last element represents V. Further, opt[φ, 0] is initialized to 0, and, for L∈L_{order}, opt[L, 0] other than opt[φ, 0] is initialized to co with respect to 0≤t≤T(V). In the case where there are other variables needing initialization, those variables may be further initialized.

Next, the optimization process is executed. The loop process may be performed for each of the lower set and time (S104, S106).

In the loop at S104 to S118 (indicated as “loop1” in FIG. 6), the operation may be performed in order on each of lower sets belonging to L_{order}. More specifically, the loop operation at S106 to S116 may be executed in order from a set having a smaller size among the lower sets.

In the loop at S106 to S116 (indicated as “loop2” in FIG. 6), the process of calculating the memory consumption in each time consumption t(={0, 1, . . . , T(V)}) and updating the relationship between the memory consumption and the time consumption may be executed for each of L′∈L_{order} having the lower set L selected in the loop from S104, as its own lower set. In other words, the operation may be executed for each time consumption for processing up to L′ in each lower set L′(L∈L′). In this loop, for example, L′ is extracted from the lower set, and the following calculation of the memory consumption may be performed in each time consumption t for the extracted L′.

In the loop (loop2 in FIG. 6), the operation is performed, for example, in the following order. For the processes in which the order of the operation may be changed, the order of the processes can be exchanged as needed. For example, the processes at S108 and S110 may be exchanged, or the process at S110 may be executed after YES is determined at S112.

First, the memory consumption calculator 16 may calculate the memory consumption (S108). For example, based on each pattern of the above memory consumption and with V′=L′−L, M=opt[L, t]+2M(V′)+M(δ⁺(L′)−L′)+M(δ⁻(δ⁺(L′)−(L′)) may be calculated as the memory consumption at the time consumption t.

Then, the time consumption calculator 18 may calculate the time consumption (S110). For example, the time consumption t′ is calculated as t′=t+T(V′−∂(L′)).

Then, the updater 20 may compare the memory consumption M calculated at 108 and the memory budget B (S112). When the memory consumption M is equal to or less than the memory budget B (S112: YES), the minimum memory consumption may be updated (S114). For example, M B, the update may be made with opt[L′, t′]=min(opt[L′, t′], opt[L, t]+M∂((L′)−L). Here, when opt[L′, t′] is updated, the update in these L′, t′ may be stored. In other words, the process in this paragraph may be a process that if opt[L′, t′]>m′ after the computation of m′=opt[L, t]+M(∂(L′)−L), the update is made with opt[L′, t′]=m′ into optarg[L′, t′]=(L, t), and the values for updating them are stored.

After the minimum memory consumption is updated as explained above or the memory consumption M exceeds the memory budget B (S112: NO), an operation may be executed for the next time consumption t. After the loop for the time consumption t is finished, an operation may be executed for the next lower set L′. As explained above, the processes at S106 to S116 (loop2 in FIG. 6) are repeated.

After the operations for all of the lower sets L′ and the time consumption t are finished, the same processes are repeated for the next L included in L_{order} (S104 to S118, i.e., loop1 in FIG. 6).

After the operation for the lower set included in L_{order} is finished, the extractor 22 may extract the optimum memory consumption having the minimum consumption time (S120). When there are optimum memory consumptions satisfying opt[V, t]<∞, the optimum memory consumption having the minimum t₀ may be extracted from among them.

Then, the strategy acquirer 24 may acquire, based on the extracted t₀, a strategy realizing such t₀ (S122). This process can acquire a strategy realizing the minimum recomputation time and the memory consumption being equal to or less than B. For example, at the timing when the minimum memory consumption is updated at S114, t′ and L′ realizing the minimum memory consumption may be stored in the storage 12, thereby making it possible to acquire the strategy based on the data stored in the storage 12 when t₀ is extracted. In other words, the increasing sequence (L₁, . . . , Lₖ) of L can be acquired as a strategy by tracing the stored oparg[L, t] in a reverse order from (V, t₀).

Further, the strategy acquirer 24 can decide the result in which operation node is to be stored in the memory, based on the thus-acquired strategy. In executing the training, in the forward propagation process, the decided result of the operation node may be stored in the memory, and it is possible that the results of the other operation nodes are not stored in the memory. In the backward propagation process, for example, a gradient may be calculated using the value stored in the memory and a value recomputed from the value stored in the memory to be used to update the network. Note that the outputter 26 may output the strategy itself acquired by the strategy acquirer 24 or may output the operation node storing the operation result decided from the strategy. Besides, when there is no strategy satisfying opt[⋅]<∞, the fact that there is no strategy may be output.

The time consumption t may be appropriately discretized as explained above and the operation time in each operation node V may be discretized and stored as Tᵥ(t_{G}(V)) in the storage 12, or the data may be input from the inputter 10. In the case where it is not easy to precisely compute the operation time in each operation node V, the operation in each operation node may be appropriately estimated and the estimated time may be set as Tᵥ. For example, the node of convolution operation may have Tᵥ=10, and the other nodes may have Tᵥ=1. In addition, in a node in which a heavy operation exists, a value other than 1 may be suitably allocated. In this manner, Tᵥ may be decided in advance by an operation. In the case of allocating a discretized value in advance, the allocated value may be input from the inputter 10, or the kind of the operation may be input for each node from the inputter 10 and a discretized value of the time consumption may be given in the optimization apparatus 1.

As explained above, according to this embodiment, it is possible to perform optimization to achieve a balance between the use of the memory in the case of executing the backward propagation and the time for recomputation of the forward propagation process. When the memory relatively has room, the time efficiency of the recomputation can be improved while consuming the memory, and when the memory has no room, the time efficiency of the recomputation can be reduced while reducing the amount of the memory consumption.

Further, by suppressing the increase in the amount of the memory consumption while suppressing the increase in computation time, for example, in the case of performing the mini batch process, the size of the mini batch can also be increased. By increasing the mini batch size, the accuracy of the batch normalization can be increased to improve the training accuracy. As explained above, not only the efficiency improvement of the memory and the recomputation time but also the accuracy of the training can be improved.

The operation loop is executed for L′ including L as a lower set in the above-explained embodiment but, is not limited to this, for example, the operation loop may be constructed for each lower set L while focusing attention on L′. In this case, the initial value, the operation sequence and so on are appropriately and suitably changed.

The boundary may be set to δ⁺(V−L). In this case, the optimization may be performed in a manner not to take the boundary of the beginning of the backward propagation into consideration. Further, for the above-explained processes of the forward propagation and the backward propagation, the boundary can be adjusted so that the boundary appropriately remains to prevent overflow of the amount of the memory consumption.

Note that the dynamic programming is used in this embodiment, but the optimum solution may be found by Brute-force attack because the number of lower sets is 2^{|v|} at most depending on the number of nodes being objects of computation included in the graph. In this case, a search may be performed based on BFS (Breath-First Search) or DFS (Depth-First Search).

The algorithm illustrated in the above flowchart can be further heuristically increased in speed. The optimization apparatus to which the aspect increased in speed is applied is also included in the content of this embodiment. Hereinafter, some other optimization examples are exemplified.

### First Example

The above method may be strictly performed by the dynamic programming from all of the lower sets, but pruning may be heuristically performed. In other words, the optimization is performed with L=L_{G} in the above strict method, but the optimization may be performed with the lower set as a set of L_{G}^{pruned}=φu{L^{v}|v∈V}, L^{v}={w∈V|v can be reached from w}. That v can be reached from w means that there are 0 or more paths of a directional branch directing from v toward w. As explained above, by performing the optimization with L=L_{G}^{pruned} in the above dynamic programming, the pruning of the lower set can be performed, and a solution which is not the strictly optimum solution but almost equivalent thereto can be found at high speed.

The number of times of loop is O(T(V)×|L_{G}|²) to O(|V|×|L_{G}|²) in the strict method, but can be made into O(|V|³) by the pruning method.

### Second Example

In the above embodiment, the case in which, for example, the gradient of each node of Vᵢ is acquired also in the backward propagation as in the forward propagation, and after the operation of parameter update and the like using the gradient is finished, the gradient information may be erased except for the node of δ⁺(Lᵢ₋₁)∩Vᵢ has been explained. Similarly, as the stage, the optimization may be performed using the memory consumption of storing all of the values recomputed by the forward propagation until the operation of the gradient is finished in each node in V. However, it is also possible to release the memory storing the data on the forward propagation nodes which have become unnecessary, while sequentially computing the gradient in the backward propagation.

For example, the strategy of the recomputation can be expressed by

(1) compute v: compute the node v, store the result in the memory, and
(2) release v: release the node v from the memory
in the above embodiment. By performing release v at a timing as earliest as possible, the memory consumption at the peak time of the operation process can be reduced.

Hence, in the strategy of the recomputation, the above change may be simply added to the command sequence, and the heuristic obtained by reducing the peak memory consumption may be given as follows. In the case where “release v” exists in the command sequence, “release v” may be moved to a step preceding as much as possible which can be performed in a state where no contradiction occurs on the command sequence, namely, the released memory is not accessed so that the release of the memory occurs at an early timing.

By adding the simple change as in the above, the memory consumption at the peak time can be reduced more. This method is described as operation sequence optimization.

The memory consumption calculator 16 can calculate the memory consumption of the focused operation node based on the memory consumption for storing the operation result in the focused operation node by the above method. The memory consumption calculator 16 can further perform accurate computation, for example, by the following method.

There is a case where a node u and a node v exist and the following command sequence may exist.

0 (initial state)

1 compute u

2 compute v

3 release u

4 release v

The maximum value of the memory usage in the state where the execution of each of the commands 0, 1, 2, 3, 4 is completed may become the value of the memory consumption to be computed. It is assumed that the memory usage increases by Mu at compute u, and decreases by Mu at release u. Based on this, when writing the memory usage in the state after execution of the commands as

### Mc0(=0), Mc1, . . . ,

### Mc0=0

Mc1=Mc0+Mu=0+Mu=Mu (increases by Mu by compute u)
Mc2=Mc1+Mv=Mu+Mv (increases by Mv by compute v)
Mc3=Mc2−Mu=(Mu+Mv)−Mu=Mv (decreases by Mu by release u)
Mc4=Mc3−Mv=Mv−Mv=0 (decreases by Mv by release v) can be obtained. The computation can be performed by computing the memory usage in each state from the command sequence and taking the maximum value of Mc0, Mc1, . . . . In the above example, Mc2=Mu+My is the maximum value. The above command sequence is an example, and the above computation is to be performed on the command sequence on which the operation sequence optimization has been performed in the actual computation.

### Third Example

The above-explained recomputation problem may require the strategy of minimizing the additional computation time. This is described as TC (Time-Centric). The optimization performed on the peak memory consumption of the strategy by the operation sequence optimization in the TC is illustrated in Second Example.

When applying the strategy obtained by maximizing the additional computation time instead of minimizing it to the operation sequence optimization, more memories can be sometimes reduced. This can be considered because a segment having a large granularity is more likely to appear in a vertex partition needing a more additional computation time and thereby the memory reduction effect by the operation sequence optimization becomes greater. The strategy obtained by maximizing the additional computation time in the above manner is described as MC (Memory-Centric). Even by maximizing the additional time, the forward propagation computation in each node needs to be performed one time at most. Hence, the MC can also be made heuristic. This can be executed by simple change such as extraction of the maximum t instead of extracting the minimum t as explained in the above when finding t₀.

The use of the above various heuristics makes it possible to perform optimization according to the purpose such as increase in speed of the operation, or minimization of the memory consumption or the minimization of the recomputation time.

### Fourth Example

The speed can be increased also in the dynamic programming. The computation time can be significantly reduced, for example, by computing opt[⋅] defined as a table in the dynamic programming as a sparse table. Further, in the case of opt[L, t]<opt[L, t′] with respect to t<t′, the computation of opt[L, t′] can also be omitted. The computation time of the dynamic programming in the above embodiment can also be reduced as explained above.

Further, for example, in the case where an unnecessary node is included in the computation stage, the computation may be made excluding such as a node, and thereby the computation of the memory consumption or the time consumption can be more precisely performed. Since, for example, the addition does not need input in the forward direction at the time of computation in the backward direction, the node having data necessary only for the addition does not need to be stored, and can be said to be an unnecessary node. By calculating the memory consumption of the focused operation node based on the memory consumption for storing the operation result in the focused operation node while excluding at least part of such unnecessary nodes and preferably all of them, more precise computation can be performed.

In the optimization apparatus 1 according to some embodiments, each function may be implemented by a circuit constituted by an analog circuit, a digital circuit, or an analog/digital mixed circuit. A control circuit which controls each function may be included in the optimization apparatus 1. Each circuit may be implemented as an ASIC (application specific integrated circuit), an FPGA (field programmable gate array), or the like.

In all of the foregoing explanations, at least a part of the optimization apparatus 1 may be constituted by hardware, or by software and a Central Processing Unit (CPU) or the like may implement the function through information processing of the software. When it is constituted by software, programs that enable the optimization apparatus 1 and at least a part of the functions may be stored in storage media, such as a flexible disk and a CD-ROM, and may be executed by being read by a computer. The storage media are not limited to detachable media such as a magnetic disk or an optical disk, and may include fixed storage media such as a hard disk device and a memory. That is, the information processing may be concretely implemented using hardware resources. For example, the processing may be implemented on a circuit such as the FPGA, and may be executed by hardware. The generation of the models and the subsequent processing of the model input may be performed by using, for example, an accelerator such as a Graphics Processing Unit (GPU).

For example, a computer may be programmed to act according to the above embodiments by dedicated software stored in a computer-readable storage medium. The kinds of storage media are not limited. The computer may be used to implement a device according to the embodiment by installing dedicated software on the computer, e.g., by downloading the software through a communication network. The information processing is thereby concretely implemented using hardware resources.

FIG. 9 is a block diagram illustrating an example of a hardware configuration according to some embodiments of the present disclosure. The optimization apparatus 1 may include a computing device 7 having a processor 71, a main storage 72, an auxiliary storage 73, a network interface 74, and a device interface 75, connected through a bus 76.

Although the computing device 7 shown in FIG. 9 includes one of each component 71-76, a plurality of the same components may be included. Moreover, although one computing device 7 is illustrated in FIG. 9, the software may be installed into a plurality of computing devices, and each of the plurality of computing devices may execute a different part of the software process.

The processor 71 may be an electronic circuit (processing circuit) including a control device and an arithmetic logic unit of the computer. The processor 71 may perform arithmetic processing based on data and programs input from each device or the like of an internal configuration of the computing device 7, and output arithmetic operation results and control signals to each device or the like. For example, the processor 71 may control each component constituting the computing device 7 by executing an OS (operating system), applications, and so on, of the computing device 7. The processor 71 is not limited to a particular processor and may be implemented by any processor capable of performing the above-stated processing.

The main storage 72 may store instructions executed by the processor 71, various data, and so on, and information stored in the main storage 72 may be directly read by the processor 71. The auxiliary storage 73 may be a storage other than the main storage 72. These storages may be implemented using arbitrary electronic components capable of storing electronic information, and each may be a memory or a storage. Both a volatile memory and a nonvolatile memory can be used as the memory. The memory storing various data in the optimization apparatus 1 may be formed by the main storage 72 or the auxiliary storage 73. For example, at least one of the storage for the optimization apparatus 1 may be implemented in the main storage 72 or the auxiliary storage 73. As another example, at least a part of the storage may be implemented by a memory which is provided at the accelerator, when an accelerator is used.

The network interface 74 may be an interface to connect to a communication network 8 through a wire or wireless interface. An interface which is compatible with an existing communication protocol may be used as the network interface 74. The network interface 74 may exchange information with an external device 9A which is in communication with computing device 7 through the communication network 8.

The external device 9A may include, for example, a camera, a motion capture device, an output destination device, an external sensor, an input source device, and so on. The external device 9A may be a device implementing a part of the functionality of the components of the optimization apparatus 1. The computing device 7 may transmit or receive a part of processing results of the optimization apparatus 1 through the communication network 8, like a cloud service.

The device interface 75 may be an interface such as a USB (universal serial bus) which directly connects with an external device 9B. The external device 9B may be an external storage medium or a storage device. At least part of the storage may be formed by the external device 9B.

The external device 9B may include an output device. The output device may be, for example, a display device to display images, and/or an audio output device to output sounds, or the like. For example, there external device may include an LCD, (liquid crystal display), a CRT (cathode ray tube), a PDP (plasma display panel), a speaker, and so on. However, the output device is not limited to these examples.

The external device 9B may include an input device. The input device may include devices such as a keyboard, a mouse, a touch panel, or the like, and may supply information input through these devices to the computing device 7. Signals from the input device may be output to the processor 71.

While certain embodiments have been described, these embodiments have been presented by way of example only, and are not intended to limit the scope of the present disclosure. Various additions, modifications, and partial deletion may be made within a range not departing from the conceptual idea and the spirit of the present disclosure which are derived from contents stipulated in the accompanying claims and their equivalents. For example, in all of the above-stated embodiments, numeric values used for the explanation are each presented by way of an example, and not limited thereto. Moreover, while certain processes and methods have been described as a series of steps, it is to be understood that the performance of these steps is not limited to the order described and that non-dependent steps may be performed in any order, or in parallel.

Besides, in this specification, “optimization” is not always limited to optimum adjustment of the efficiency of the recomputation. In other words, optimization may be performed to make even a part of the recomputation efficient. Further, it is assumed that the “optimization apparatus” means an apparatus capable of performing such a process.

1. An optimization apparatus comprising:
one or more memories; and
one or more processors configured to, for an operation node constituting an operation of a neural network:
calculate a time consumption, from another operation node whose operation result has been stored, for recomputing an operation result of a focused operation node; and
acquire data for the operation node whose operation result is to be stored, based on the time consumption.

2. The optimization apparatus according to claim 1, wherein
the one or more processors are further configured to:
calculate a memory consumption for recomputing the operation result of the focused operation node,
wherein the acquired data is further based on the memory consumption.

3. The optimization apparatus according to claim 2, wherein
the one or more processors are configured to calculate the memory consumption using a lower set capable of performing recomputation of the focused operation node by the operation node included in the lower set, the lower set being based on an operation sequence in a forward propagation process in the representation.

4. The optimization apparatus according to claim 3, wherein
the one or more processors are configured to calculate the memory consumption based on a memory consumption in an area of nodes until the focused operation node is reached in the forward propagation process.

5. The optimization apparatus according to claim 3, wherein
the one or more processors are configured to calculate the memory consumption based on a memory consumption for storing the operation result of the focused operation node.

6. The optimization apparatus according to claim 3, wherein
the one or more processor are configured to calculate the memory consumption based on a memory consumption for storing an operation result of the lower set having the focused operation node as a boundary.

7. The optimization apparatus according to claim 3, wherein
the one or more processors are configured to calculate, when using an operation result of a gradient in the another operation node at the time of operating a gradient in the focused operation node, the memory consumption based on a memory consumption for storing the operation result of the gradient in the another operation node.

8. The optimization apparatus according to claim 3, wherein
the one or more processors are configured to calculate the time consumption by calculating a recomputation time from the operation node whose operation result is stored in the lower set having the focused operation node as a boundary.

9. The optimization apparatus according to claim 3, wherein
the one or more processors are configured to calculate the memory consumption while excluding at least part of operation nodes not used for the recomputation.

10. The optimization apparatus according to claim 2, wherein
the one or more processors are configured to acquire, when the memory consumption has been calculated, a memory consumption whose corresponding time consumption is minimum.

11. An optimization method for an operation node constituting an operation of a neural network, the method comprising:
calculating, by one or more processors, a time consumption, from another operation node whose operation result has been stored, for recomputing an operation result of a focused operation node; and
acquiring, by the one or more processors, data for the operation node whose operation result is to be stored, based on the time consumption.

12. The optimization method according to claim 11, further comprising:
calculating, by the one or more processors, a memory consumption for recomputing the operation result of the focused operation node; and
acquiring, by the one or more processors, the data further based on the memory consumption.

13. The optimization method according to claim 12, further comprising:
calculating, by the one or more processors, the memory consumption using a lower set capable of performing recomputation of the focused operation node by the operation node included in the lower set, the lower set being based on an operation sequence in a forward propagation process in the representation.

14. The optimization method according to claim 13, further comprising:
calculating, by the one or more processors, the memory consumption based on a memory consumption in an area of nodes until the focused operation node is reached in the forward propagation process.

15. The optimization method according to claim 12, further comprising:
acquiring, by the one or more processors, when the memory consumption has been calculated, a memory consumption whose corresponding time consumption is minimum.

16. A non-transitory computer readable medium storing a program configured to cause one or more processors to, for an operation node constituting an operation of a neural network:
calculate a time consumption, from another operation node whose operation result has been stored, for recomputing an operation result of a focused operation node; and
acquire data for the operation node whose operation result is to be stored, based on the time consumption.

17. The non-transitory computer readable medium according to claim 16, wherein the one or more processors are caused to:
calculate a memory consumption for recomputing the operation result of the focused operation node; and
acquire the data further based on the memory consumption.

18. The non-transitory computer readable medium according to claim 17, wherein
the one or more processors are caused to calculate the memory consumption using a lower set capable of performing recomputation of the focused operation node by the operation node included in the lower set, the lower set being based on an operation sequence in a forward propagation process in the representation.

19. The non-transitory computer readable medium according to claim 18, wherein
the one or more processors are caused to calculate the memory consumption based on a memory consumption in an area of nodes until the focused operation node is reached in the forward propagation process.

20. The non-transitory computer readable medium according to claim 17, wherein
the one or more processors are caused to acquire, when the memory consumption has been calculated, a memory consumption whose corresponding time consumption is minimum.
